(19) United States
(12) Patent Application Publication
(10) Pub. No.: US 2016/0270623 A1
(43) Pub. Date: Sep. 22, 2016

(54) HEATED CLEANING ARTICLES USING A REACTIVE METAL AND OXYGEN HEAT GENERATOR

(71) Applicant: THE CLOROX COMPANY, OAKLAND, CA (US)

(72) Inventors: BRYAN K. PARRISH, PLEASANTON, CA (US); KERRY AZELTON, PLEASANTON, CA (US); BRIAN LIN, PLEASANTON, CA (US); VISMADEB MAZUMDER, SAN JOSE, CA (US); MARIA G. OCHOMOGO, PLEASANTON, CA (US); WIALLIAM R. OUELLETTE, LIVERMORE, CA (US); MICHAEL J. PETRIN, WALNUT CREEK, CA (US); RICHARD URIARTE, DANVILLE, CA (US)

(73) Assignee: THE CLOROX COMPANY, OAKLAND, CA (US)

(21) Appl. No.: 15/057,505

(22) Filed: Mar. 1, 2016

Related U.S. Application Data
(60) Provisional application No. 62/140,384, filed on Mar. 30, 2015.
(60) Provisional application No. 62/134,264, filed on Mar. 17, 2015.

(51) Int. Cl. A47L 13/22; B08B 3/08; A47L 13/17; F24J 1/00; F24J 3/00; B08B 1/00; B08B 3/10

(52) U.S. Cl. CPC A47L 13/225; B08B 1/006; B08B 3/08; B08B 3/10; F24J 1/00; F24J 3/00; A47L 13/17

(57) ABSTRACT

Cleaning articles including a heat engine incorporated therein. The cleaning article may include a substrate (e.g., a non-woven wipe) including one or more layers. The heat engine may be in the wipe or pad, and includes a reactive metal composition which upon contact with oxygen, reacts to produce heat. The cleaning article may thus heat water or a cleaning composition, and may produce water vapor and/or steam upon activation of the heat engine. A venting structure may be adjacent to the heat engine, and may include one or more vents through the impermeable material. The venting structure may allow air to access the reactive metal composition, and/or may direct water vapor and/or steam to a desired face of the cleaning article, away from the user. A heat barrier layer may insulate a user's hand from the generated heat, and/or a handle may be attachable to the pad.

### CROSS-REFERENCE TO RELATED APPLICATIONS

This application claims priority to and the benefit of U.S. Provisional Patent Application No. 62/140,384 filed Mar. 30, 2015, entitled HEATED CLEANING ARTICLES USING AN OXYGEN ACTIVATED HEAT GENERATOR, which is incorporated by reference in its entirety. This application also claims priority to and the benefit of U.S. Provisional Patent Application No. 62/134,264 filed Mar. 17, 2015, entitled HEATED CLEANING ARTICLES USING A REACTIVE METAL AND SALINE HEAT GENERATOR, which is incorporated by reference in its entirety.

### BACKGROUND OF THE INVENTION

1. The Field of the Invention

The present invention relates to self-heated cleaning articles, e.g., a wipe or other cleaning substrate that includes a heat engine capable of producing heat that can be used in delivering a cleaning composition (which may simply be heated water) in a heated condition, to improve cleaning efficacy.

2. Description of Related Art

Cleaning devices and articles (e.g., wipes) are used extensively in cleaning various environments both at home, and in various other settings (e.g., hospitals, retail centers, restaurants, businesses, assisted living centers, etc.). While heated water (and/or other heated cleaning compositions) may be recognized to provide improved cleaning efficacy, there is little in the way of consumer products currently available that conveniently provide heat at the time and place where cleaning is to occur, e.g., that would heat the cleaning composition at the time of use, in a substantially automated fashion.

### BRIEF SUMMARY OF THE INVENTION

Although there exist various products that employ heat generators that use exothermic reactions to generate heat (e.g., in heating MRE meals, hand and boot warmers, and the like), heat generators have not been adapted for use in cleaning articles. Heat and/or steam dramatically improves the efficacy of many cleaning compositions and/or the cleaning substrate itself, and there is a need for convenient, safe, self-heating cleaning articles that consumers may easily use for various cleaning applications. According to one embodiment, the present invention relates to use of a reactive metal that generates heat within the cleaning article (e.g., a wipe) itself upon exposure of the reactive metal to oxygen (e.g., air). The reactive metal may be stored within a pouch or other container that is impermeable to air, and which is broken or otherwise opened when heating is desired. The pouch or other container may optionally be resealable.

Use of such a reactive metal and air heat generator with a cleaning article presents a number of difficulties to be addressed in order to create a product safe for consumer use. For example, some such difficulties may include the ability to provide control over the amount of oxygen or air added to the reactive metal, control of temperatures achieved by the heat engine, and the like. Embodiments of the invention as described herein may address one or more of the above issues.

One aspect of the invention is directed to a cleaning article comprising a substrate material comprising one or more layers. The cleaning article may further include a heat engine including a reactive metal composition. The reactive metal composition is activated upon contact with oxygen (e.g., air). The reactive metal composition may be provided within a pouch or other container within the cleaning article (e.g., configured as a wipe or pad). The pouch or other container may be impermeable to oxygen (e.g., air), so as to be broken or otherwise opened at time of use. Upon contact of reactive metal with the activating oxygen, heat is generated.

The cleaning article may further include a venting structure adjacent to or surrounding the heat engine, which venting structure may include a material that is impermeable to moisture and/or air. One or more vents (e.g., holes) may be formed through the impermeable material, to allow steam and/or water vapor generated by the heat engine to be directed through the vent(s) to at least one surface of the cleaning article. For example, steam and/or water vapor could be generated by heating water or a cleaning composition present in the wipe, pad, or other cleaning article. For example, the venting structure may direct the steam and/or water vapor to the face of the cleaning article that the user presses against the surface being cleaned (e.g., tile, countertop, sink, bathtub, etc.).

Exemplary substrate and other layers may include nonwoven natural fibers (cotton, pulp, etc.), nonwoven synthetic materials (polyethylene, polypropylene, polyester, etc.), a nonwoven comprising both natural and synthetic fibers, foils (aluminum film, a heat shield, etc.), membranes (water/moisture impermeable, air-impermeable, air permeable, etc.), foams, woven materials, sponges, or combinations thereof.

As mentioned, an embodiment of the heated cleaning article of the invention may include a substrate material including one or more layers, and a heat engine (e.g., surrounded by the substrate material(s). A heat barrier layer and/or venting structure may also be provided. The heat engine includes a reactive metal composition, e.g., provided in a air impermeable pouch that is frangible or openable and resealable. In an embodiment, a handle may be provided, attachable to the wipe, pad, or other cleaning article.

In any embodiment, the heat generator may heat the substrate material and the user may use the heated substrate for a wide variety of cleaning applications. In addition to heating the substrate, where water or another cleaning composition is provided within the wipe, pad, or other cleaning article, heating of such water or cleaning composition may result in generation and emission of heated water vapor and/or steam emitted from the substrate, aiding in cleaning. The temperature provided by the heat engine, and the length of time that such heat is provided, may depend on the amount of reactive metal, and flow of activating oxygen into the heat engine.

Further features and advantages of the present invention will become apparent to those of ordinary skill in the art in view of the detailed description of preferred embodiments below.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an exemplary cleaning article according to an embodiment of the present invention, including a handle attachable thereto;

FIG. 2 is an exploded view of the cleaning article of FIG. 1;

FIG. 3 a cross-sectional view through the cleaning article of FIG. 1;

FIG. 4 is a perspective view of another exemplary cleaning article according to an embodiment of the present invention, configured for hand-held use;

FIG. 4A shows the cleaning article of FIG. 4 positioned within an outer air impermeable pouch;

FIG. 5 is an exploded view of the cleaning article of FIG. 4;

FIG. 6 is a cross-sectional view through the cleaning article of FIG. 4;

FIG. 7 is a perspective view showing an exemplary cleaning article being used to scrub a bathtub or shower;

FIG. 8 is a perspective view showing an exemplary cleaning article being used to scrub a stove; and

FIG. 9 is a perspective view of an exemplary cleaning device held in a user's hand in preparation for use.

### DETAILED DESCRIPTION OF THE PREFERRED EMBODIMENTS

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

References herein to “one embodiment”, “one aspect” or “one version” of the invention include one or more such embodiment, aspect or version, unless the context clearly dictates otherwise.

The term “comprising,” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “layer” includes one, two or more such layers.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

Some ranges may be disclosed herein. Additional ranges may be defined between any values disclosed herein as being exemplary of a particular parameter. All such ranges are contemplated and within the scope of the present disclosure.

Numbers, percentages, ratios, or other values stated herein may include that value, and also other values that are about or approximately the stated value, as would be appreciated by one of ordinary skill in the art. A stated value should therefore be interpreted broadly enough to encompass values that are at least close enough to the stated value to perform a desired function or achieve a desired result, and/or values that round to the stated value. The stated values include at least the variation to be expected in a typical manufacturing or formulation process, and may include values that are within 10%, within 5%, within 1%, etc. of a stated value. Furthermore, the terms “substantially”, “similarly”, “about” or “approximately” as used herein represent an amount or state close to the stated amount or state that still performs a desired function or achieves a desired result. For example, the term “substantially” “about” or “approximately” may refer to an amount that is within 10% of, within 5% of or within 1% of, a stated amount or value.

Unless otherwise stated, all percentages, ratios, parts, and amounts used and described herein are by weight.

As used herein, the terms “cleaning article”, “pad”, and “wipe” are intended to include any material which may be used for a cleaning application. In functional application, cleaning article is used to clean a surface, e.g., such as by wiping, rubbing or scrubbing. The cleaning article includes a substrate. Substrates comprise woven or non-woven materials, typically made from a plurality of fibers, as well as sponges, films and similar materials into which the heat engine can be packaged, as described herein. The cleaning article can be used by itself (typically by hand) or attached to a cleaning implement, such as a handle, a floor mop, or a hand-held cleaning tool, such as a toilet cleaning device, or similar.

“Cleaning composition” or “treatment composition” as used herein, is any fluid and/or solid composition used for cleaning or treating hard surfaces, soft surfaces, air, etc. Cleaning means any treatment of a surface which serves to remove or reduce unwanted or harmful materials such as soil, dirt, spills, debris, spores, mold or microbial contamination from a surface, and/or which imparts a desirable or beneficial aesthetic, health or safety effect to the surface such as depositing thereon a fragrance, color or protective coating or film.

In an embodiment, the cleaning composition may include an abrasive, e.g., including, but not limited to exfoliating particles such as calcium carbonate, pumice, salts, sugar, and the like. In an embodiment of the invention, any cleaning composition may include a salt or electrolyte including, but not limited to, potassium hydroxide, sodium hydroxide, sodium chloride, and the like.

As used herein, the term “x-y dimension” refers to the plane orthogonal to the thickness of a substrate sheet. The x and y dimensions correspond to the length and width, respectively, of the sheet. In this context, the length of the sheet is the longest dimension of the sheet, and the width the shortest. Of course, the present invention is not limited to the use of cleaning substrates having a rhomboidal shape. Other shapes, such as circular, elliptical, and the like, can also be used.

As used herein, the term “z-dimension” refers to the dimension orthogonal to the length and width of the cleaning substrate, or a component thereof. The z-dimension therefore corresponds to the thickness of the cleaning substrate, article, or component thereof. As used herein, the term “z-dimension expansion” refers to imparting bulk or thickness to a fibrous web by moving fibers out of the x-y dimension and into the z-dimension. A fibrous web with z-dimension expansion can be created by a wide variety of methods, including but not limited to, air texturing, abrasion bulking, embossing, thermoforming, felting, SELFing and any other suitable methods.

As used herein, the term “fiber” refers to a thread-like object or structure from which textiles and non-woven fabrics are commonly made. The term “fiber” is meant to encompass both continuous and discontinuous filaments, and other thread-like structures having a length that is substantially greater than its diameter.

As used herein, the terms “non-woven” or “non-woven web” means a web having a structure of individual fibers or threads which are interlaid, but not in a regular and identifiable manner as in a woven or knitted web. The fiber diameters used in non-wovens are usually expressed in microns, or in the case of staple fibers, denier. Non-woven webs may be formed from many processes, such as, for example, by meltblowing, spunbonding, carded, airlaid, wetlaid, thermal bonded, needled/felted, hydroentangled, and/or combinations thereof.

### II. Introduction

The present invention relates to the incorporation of heat engines into a cleaning article. The cleaning article may include a substrate (e.g., a non-woven wipe) including one or more layers. A heat engine may be incorporated into the cleaning article (e.g., into the layers of the wipe or pad). The heat engine may include a reactive metal composition which upon contact with oxygen (e.g., air), reacts to produce heat. It will be appreciated that sources of oxygen other than air could also be used (e.g., oxygen released from an oxidizer such as hydrogen peroxide, a hypohalite compound, or per-compounds (e.g., sodium peroxide, sodium perborate, perchlorate salts, and the like). The reactive metal may initially be provided within an impermeable pouch or other container, which may be opened, or ruptured, to provide the contact with the reacting oxygen at the time of use. Heat provided by the heat engine may be used to heat a cleaning composition provided with the wipe or pad. For example, such heating may cause formation of steam and/or heated water vapor that may be emitted from the wipe or pad.

### III. Exemplary Heated Cleaning Articles

In the context of the present invention, the terms “heat engine” and “heat generator” are used interchangeably with one another. A heat engine includes a composition of one or more reactive metals. By way of example, the reactive metal composition may be selected from the group consisting of: zinc, aluminum, magnesium, iron, and mixtures thereof. Various other elemental metals, alkali metals, alkaline earth metals, metalloids, and/or semiconducting metals that react with oxygen exothermically, to generate a temperature change may also be suitable for use. Combinations of one or more such materials may be employed. Elemental zinc has been found to be particularly suitable.

The reactive metal may be provided as a particulate (e.g., powder) form within a pouch or other suitable container. The reactive metal may be formed into a shaped article of any desirable shape (e.g. flat rectangle, rod, strip, etc.) In any case the reactive metal composition should be kept isolated from oxygen prior to reacting with the activating oxygen (e.g., air, or another oxygen source). To ensure that the heat generator is not inadvertently activated during production, transportation, shipping, handling or inadvertent action by the consumer, the reactive metal composition may be packaged within a protective oxygen impermeable membrane or pouch. For example, such a membrane may be impermeable to oxygen, and air. Impermeability to liquids, such as water, may also be provided by the pouch.

Where the heat engine relies on oxidation of zinc metal, contact with oxygen may initiate the following exothermic reaction:

2Zn+O₂→>2ZnO+Heat (1)

Other components may also be present with the zinc or other reactive metal in the heat engine. For example, a promotor may be provided, which promotes reduction of the oxygen. A binding agent may be present, which may aid in providing a porous matrix within which the zinc or other metal is dispersed. An electrolyte may be included. By way of example, the binding agent may be a flexible, porous matrix material, such as a polymer (e.g., polytetrafluoroethylene). Carbon is a particularly suitable promotor. Potassium hydroxide is an example of an electrolyte. Such electrolytes may speed the reaction of the zinc or other metal via the additional action of hydrolysis (e.g., where water is present).

Zinc and/or other metal powder(s) may be used in the heat engines. When other factors are held constant, the rate of liberation of heat is related to the surface area of the zinc reacting with the oxygen. The presence of carbon or another promotor with the zinc has been found to accelerate the reaction. In addition, the size of the metal particles can be selected to provide desired reaction results. For example, more finely divided zinc powder reacts more rapidly and generates heat more quickly. Such may generate higher temperatures. Coarser powders (larger particle sizes) react at a slower rate and generate heat more slowly, generating relatively lower temperatures. Zinc and other metal turnings (e.g. machining debris, ribbons and/or wires) react at an even slower rate and take longer to generate heat, although such larger “particles” may react and provide the heat over a longer time period. The rate of the reaction of the reactive metals with oxygen is thus a function of the collective surface area of the reactive metal(s) used.

Another mechanism for speeding up the reaction rate is by increasing the flow rate of oxygen to the reactive metal composition. A barrier material may be chosen to surround the heat engine that allows the user to control the amount of air or oxygen flowing to the reactive metal composition. The barrier material may have one or more re-sealable openings that would allow a user to selectively open and close off one or more openings to restrict or allow oxygen ingress as desired. In an embodiment, the heat engine may be turned off completely by preventing all oxygen flow and then may optionally be restarted when oxygen flow is again re-established and allowed to come into contact with the reactive metal composition.

In an embodiment of the invention, the weight percentage of reactive metal (e.g. zinc, aluminum, iron, combinations thereof, etc.) as a percentage of the total heat engine composition may be from about 85% to 100%, from about 85% to about 99% from about 90% to about 98% or from about 92% to about 98% by weight (e.g., 90%, 91%, 92%, 93%, 94%, 95%, 96%, 97%, 98%, or 99%).

In an embodiment of the invention, the weight percentage of a promoter material (e.g., carbon) in the heat engine as a percentage of the reactive metal composition may be from 0% to about 50%, from about 1% to about 50%, from about 10% to about 45% from about 10% to about 30%, from about 5% to about 30%, from about 15% to about 30%, or from about 20% to about 30% by weight (e.g., 20%, 21%, 22%, 23%, 24%, 25%, 26%, 27%, 28%, 29%, or 30%).

The weight percentage of an electrolyte in the heat generator composition may be from 0% to about 45%, from about 1% to about 45%, from about 5% to about 40%, from about 10% to about 35%, from about 10% to about 30%, from about 15% to about 30%, or from about 20% to about 25% by weight (e.g., 3%, 5%, 8%, 10%, 12%, 15%, 18%, 20%, 22%, 24%, 26%, 28%, 30%). Halides of alkali metals, (e.g., sodium chloride, potassium chloride, etc.), or halides of alkali earth metals may be used. Other various salts capable of forming an electrolytic solution may also be suitable for use. A combination of two or more different salts may be employed.

The weight percentage of binder in the heat generator composition may range from 0% to about 25%, from about 0.01% to about 25%, from about 0.1% to about 25%, from about 0.05% to about 20%, from about 0.1% to about 10%, from about 0.05% to about 10%, from about 0.05% to about 8%, from about 0.05% to about 8%, from about 0.05% to about 1% by weight (e.g., 0.01%, 0.025%, 0.1%, 0.25%, 0.5%, 1%, 2%, 3%, 4%, 5%, 6%, 7%, 8%, 9%, or 10%).

Suitable examples of heat engines using metallic particles are described in U.S. Pat. No. 4,017,414 and U.S. Publication No. 2010/0163011, each of which is hereby incorporated by reference in its entirety.

It should be appreciated by one skilled in the art that modifying the size of the reactive metal particles or the amounts of reactive metals and/or the concentration characteristics of any promotor and/or electrolyte may affect the reaction rate, generating heat more slowly or quickly. Depending on the application, the components of the heat engine can be adjusted to generate a warm cleaning article, a steaming cleaning article or a very hot cleaning article.

In addition, if the addition of air or oxygen is restricted (e.g. through a barrier material, providing relatively slow flow through a membrane or restricted path, etc.) in its ability to react with the reactive metal composition, then the time period over which heat is generated may either be shortened (e.g. greater oxygen exposure generating heat faster) or extended (e.g. restricting oxygen exposure) as desired. In addition, if the air/oxygen is completely restricted the heat generator may be turned off and then turned on again when exposed once again to air or oxygen.

In an embodiment, the heat engine heats the cleaning article to a temperature that is above ambient temperature (e.g., at least about 70° F.). More typically, the temperature achieved may be from about 70° F. to about 220° F., from about 80° F. to about 212° F., from about 80° F. to about 180° F., from about 100° F. to about 160° F., from about 110° F. to about 160° F., from about 110° F. to about 150° F., from about 110° F. to about 140° F., from about 115° F. to about 130° F., from about 115° F. to about 160° F., from about 115° F. to about 150° F., from about 115° F. to about 160° F., or from about 120° F. to about 160° F. Even higher temperatures can be achieved, if desired (e.g., from about 80° to about 280° F., from about 100° F. to about 260° F., or from about 110° to about 240° F. Various ranges between any of the disclosed end point temperatures are also contemplated. The actual temperature achieved may be selected based on the contemplated use. For example, for a hand-held article, the temperature may be lower than for an article provided with a handle, where there is less risk of a user accidentally touching the heated surface.

As described herein, the heat engine comprises a reactive metal composition, such as elemental zinc that generates heat upon contact with oxygen. While other chemical technologies exist for creating heat, such a heat engine that relies on reaction of a reactive metal with oxygen advantageously provides for sufficient heat production relative to the mass or volume of the heat engine components, and advantageously does not generate hydrogen or other potentially dangerous gases during use. The reactive metal and oxygen heat engine is thus economical, reliable, and generally safe for consumer use as described herein.

Depending on the contemplated use of the cleaning article, the temperature may be regulated to not exceed a given maximum. For example, exposure to heated water, water vapor, or other heated article can result in a burn to a user's skin if contact exceeds a certain time frame as shown in Table 1 below. Thus, in an embodiment, the temperature may be regulated to minimize the risk of burning. In addition, the cleaning article may include venting structure and/or a heat shield to further protect the user from risk of burning. In some embodiments, the cleaning article may include an attachable handle. Any of such features may allow the cleaning article to provide relatively higher temperatures, while still ensuring adequate safety for the user.

TABLE 1

| | | |
|---|---|---|
| Temp. | Approx. Time to | Approx. Time to 2^{nd} |
| (° F.) | 1^{st} Degree Burn | or 3^{rd} Degree Burn |

| | | | | |
|---|---|---|---|---|
| 111 | 270 | min | 300 | min |
| 113 | 120 | min | 180 | min |
| 116 | 20 | min | 45 | min |
| 118 | 15 | min | 20 | min |
| 120 | 8 | min | 10 | min |
| 124 | 2 | min | 4.2 | min |
| 131 | 17 | sec | 30 | sec |
| 140 | 3 | sec | 5 | sec |

| | | | |
|---|---|---|---|
| 151 | instant | 2 | sec |

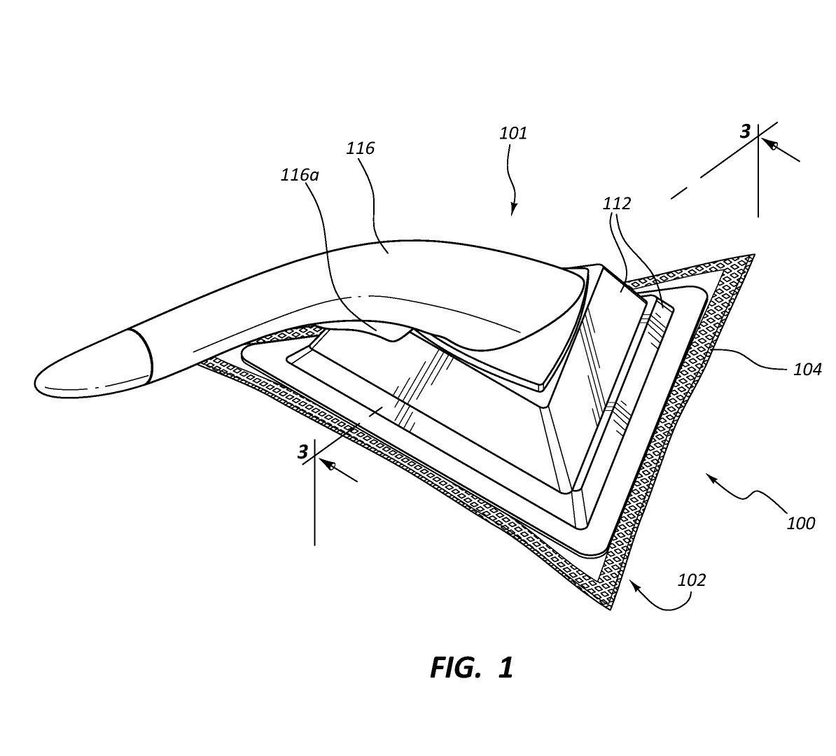

FIGS. 1-3 illustrate an exemplary cleaning article 101 according to an embodiment of the present invention, configured as a pad 100 with an attachable handle 116. Pad 100 is selectively heatable, including a heat engine 110 disposed therein. Pad 100 further includes a substrate material 104, which may include one or more layers (e.g., 104a and 104b). One or more of such layers may be a non-woven, or other suitable substrate material. One of such layers (e.g., b), is shown disposed at a “bottom” surface 102 of the pad 100, e.g., that surface of the pad 100 that is brought to bear against tile, countertop, sink, or other surface to be cleaned.

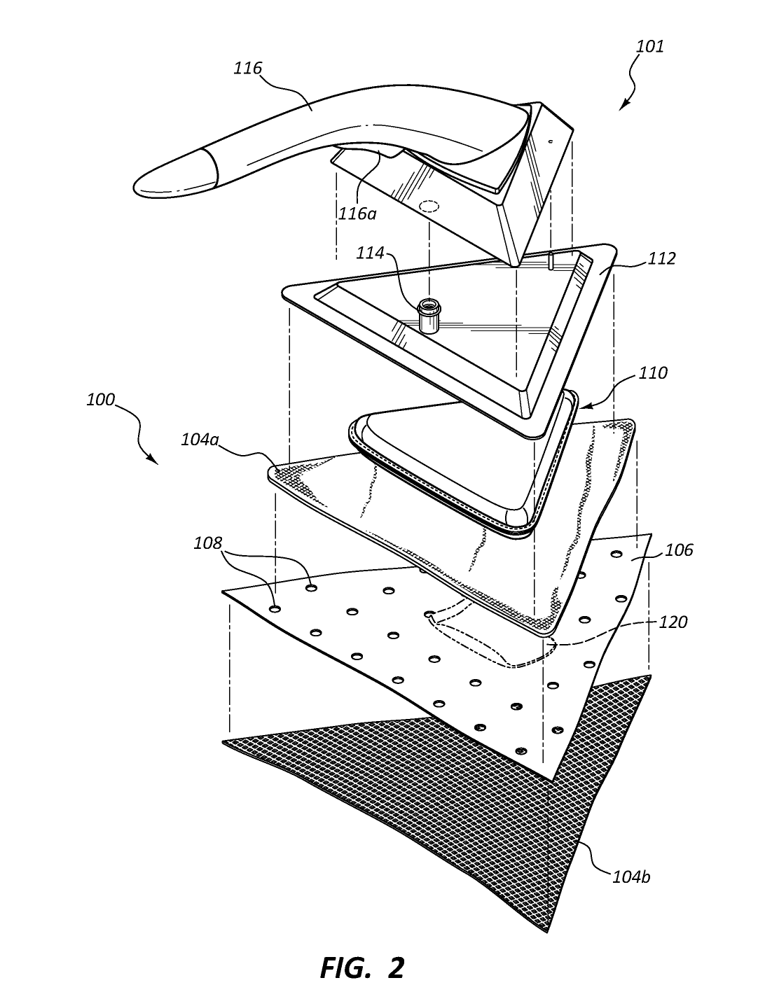

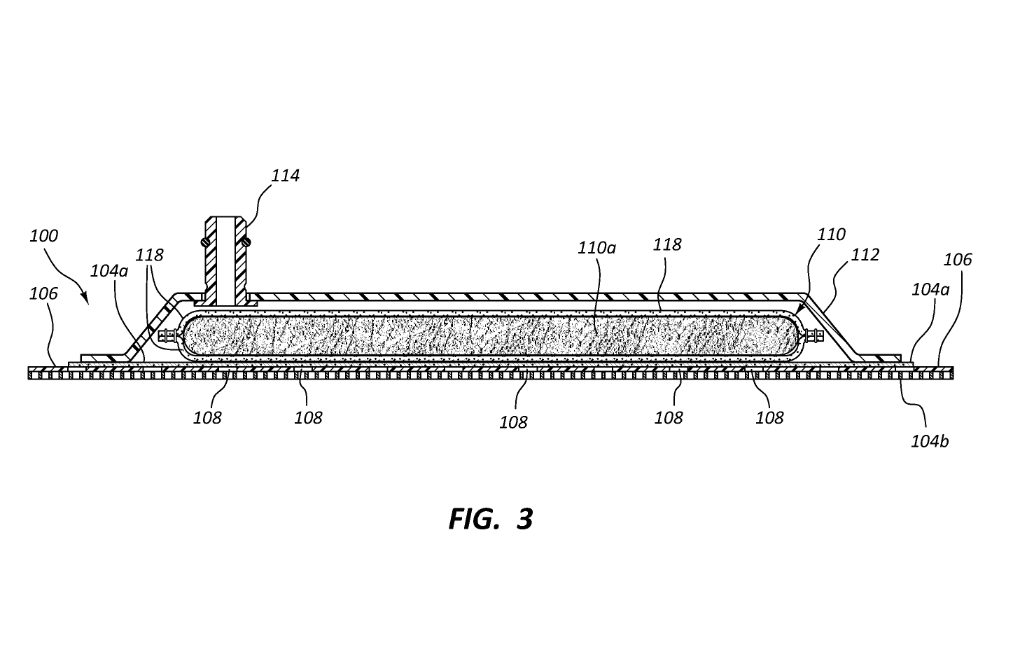

FIG. 2 shows an exploded view, better illustrating several of the various layers and components that may be included within the cleaning pad 100. Substrate 104 is shown as including a second layer, 104a, with a liquid impermeable layer at 106 (e.g., polypropylene, polyethylene or the like), e.g., disposed between the substrate layers 104a and 104b. As shown in FIG. 2, layer 106 is shown as including a plurality of vent holes 108 punched or otherwise formed therethrough. Such a layer 106 may serve to regulate flow of oxygen into heat engine 110. Additionally or alternatively, it may also serve as a venting structure to direct flow of any generated steam and/or water vapor formed from water or a cleaning composition to be forced to be emitted in a direction of the “bottom” surface of the cleaning pad, so that any such steam and/or water vapor exits through vents 108, and passes through substrate layer 104b (e.g., a non-woven material, e.g., “scrim”, as commonly referred to by those of skill in the art). Holes or vents 108 may be provided randomly across all or a portion of layer 106, or may be provided in a pattern across layer 106, as shown. The size and/or spacing of such vents 108 may alter the heating characteristics provided by heat engine 110, by regulating flow of oxygen into contact with reactive metal 110a (see FIG. 3).

Substrate layer 104a may be a non-woven material, similar to layer 104b. Such layer 104a may be the same or different than layer 104b, e.g., it may be a loft layer, or “hammock” as sometimes referred to by those of skill in the art. Layer 104a and or layer 104b may advantageously be absorbent, aiding in minimizing seepage or dripping of any cleaning composition, water or other liquids that may be present in pad 100. Rigid housing 112 may also serve to isolate compression forces applied by pressing on the handle or otherwise on the pad 100, which isolation can aid in preventing or minimizing seepage of liquid water from pad 100 as pressure is applied on the handle, to better scrub with pad 100.

Illustrated article 101 is also shown as including a scaffold or housing 112, disposed over the top face of heat engine 110. Such housing 112 may be rigid, and may include connection structure 114 for connection of the cleaning pad 100 to handle 116. Any suitable connection structure may be employed between such housing 112 of the cleaning article 100 and the handle 116. For example, various press-fit, friction-fit, screw-in, clam-shell, or other suitable mechanical couplings will be apparent to those of skill in the art. Such a connection structure 114 may be releasable, so as to allow selective connection of the handle 116 to a cleaning pad 100, use of the cleaning pad, and release of the cleaning pad after such use. The mechanism may allow release of cleaning pad 100 from handle 116 without requiring the user to touch or grip the heated cleaning pad 100. For example, a release button or other mechanism could be provided on handle 116 for selective release of the heated cleaning pad 100 after use.

The handle 116 may be configured to be used multiple times, while individual cleaning pads 100 may be intended for a single use upon activation, after which the spent cleaning pad 100 may be released from the handle 116 and disposed of. For example, a handle 116 may be provided in a package with a plurality of such cleaning pads (e.g., 3 to 10 of such pads, or any desired number). Packages of replacement cleaning pads may also be provided (e.g., 3 to 10 pads, or any desired number), without any such handle 116, to be purchased by a user who is in need of additional cleaning pads, and who already has the handle 116.

Where a rigid scaffold or housing 112 is provided on or within the cleaning article 101, a user may thus more easily apply pressure to the pad 100 of cleaning article 101, (e.g., pushing it against the surface being cleaned, using a handle, or simple hand-pressure), while minimizing a risk that cleaning composition or liquid within the cleaning pad 100 would be squished out therefrom. The cross-section of FIG. 3 illustrates how such a rigid housing 112 may largely isolate most of layers 104a and 104b from compression, that might otherwise press any liquids absorbed within such layers, and/or in heat engine 110. In one embodiment, the temperature could also be modulated by modifying housing 112 with air channels.

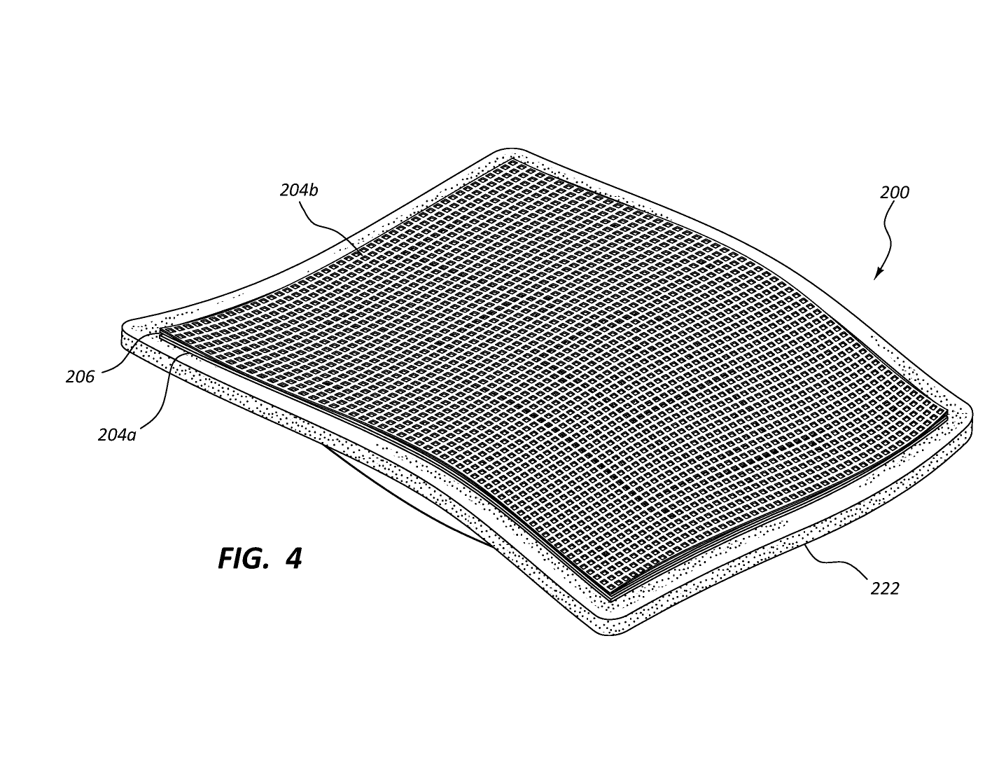

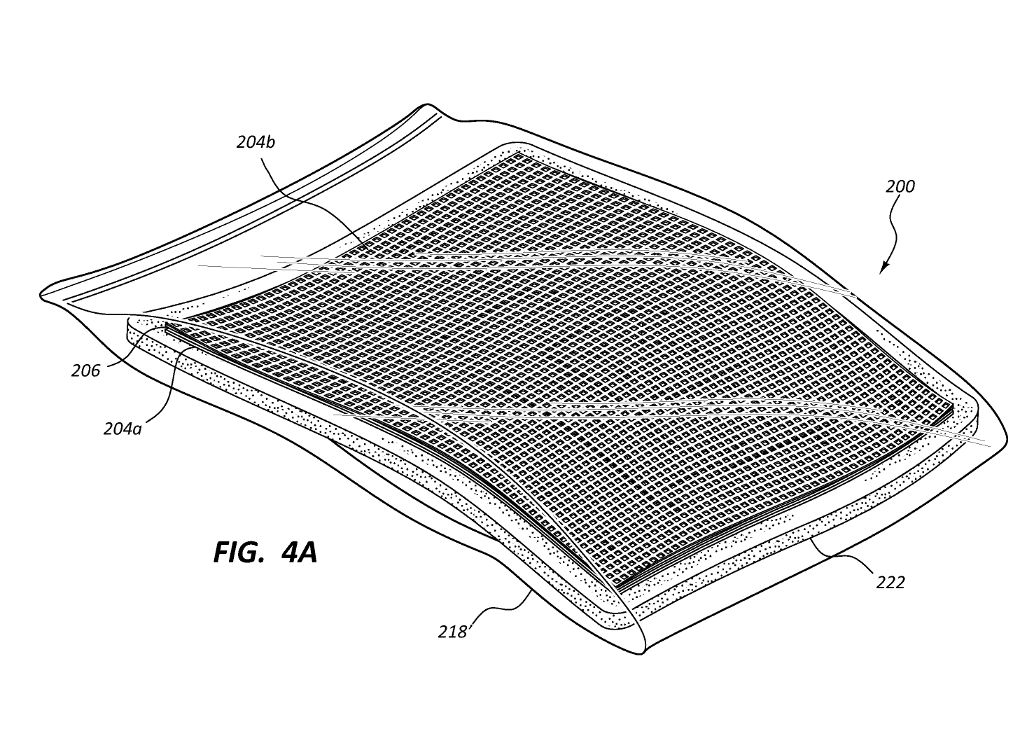

As described herein, various mechanisms for providing the activating oxygen to the reactive metal of the heat engine 110 are contemplated. Heat engine 110 may be initially sealed, e.g., with reactive metal composition 110a sealed within a pouch 118 that is impermeable to oxygen. Such pouch 118 may be ruptured or otherwise opened when activation of the heat engine 110 is desired. For example, this may be achieved by twisting, piercing, bending, pulling on a pull tab, etc., to open pouch 118. Such opening of the pouch may be irreversible (e.g., rupture or bursting), or may be reversible, whereby the pouch can be resealed. A resealable pouch allows a user to use the heat engine for a desired period of time, and then reseal the heat engine, stopping the exothermic reaction. Unused reactive metal could be used at a later time by reopening the pouch. FIG. 4A, described below, shows a wipe or pad with a resealable pouch. Where a handle 116 is provided, the handle may include piercing structure (not shown) that pierces the pouch 118, upon attachment of handle 116 to pad 100. For example, a button or trigger 116a on handle may be pressed or otherwise actuated to pierce or otherwise open the pouch 118, activating the heat engine 110.

While button 116a is illustrated, it will be appreciated that various buttons, triggers, and the like could alternatively be employed. Use of the term “button” is to be broadly construed to include such a variety of mechanisms. In an embodiment, pouch 118 could be formed of a water-dissolvable membrane material, which is impermeable to air, but upon contact with water, it is dissolved. In such an embodiment, water could be added to heat engine 110 through handle 116. Contact of water with dissolvable pouch 118 would result in exposure of reactive metal 110a (e.g., zinc) to the oxygen in the air, and activation of the heat engine.

To create the oxygen impermeable pouch or other container housing the reactive metal composition, the interior of the pouch could be vacuum sealed, flushed with a non-reactive gas (e.g., carbon dioxide, nitrogen, or the like), or compressed prior to sealing to expel gas or air present therein.

FIG. 2 illustrates inclusion of an optional pouch of cleaning composition 120, e.g., disposed between the heat engine 110 and the bottom substrate layer 104b. Such pouch may be permeable, burstable, or otherwise activated so that the cleaning composition disposed therein is heated by heat engine 110. Such composition 120 may include water, which may be heated to generate steam and/or water vapor. Such steam or water vapor may be directed to exit pad 100 through vents 108 in layer 106. In another embodiment, such a cleaning composition 120 may simply be applied to one or more layers of the substrate 104 (e.g., layer 104a and/or 104b, pouch layer 118 of heat engine 110), or elsewhere in pad 100, so that it is heated by heat engine 110, for use in cleaning (e.g., scrubbing with substrate layer 104b). Pouch of cleaning composition 120 is not shown in the cross-sectional view of FIG. 3 for simplicity, and as its presence is optional.

As will be appreciated from FIG. 3, venting structure provided by impermeable layer 106, with vents 108 formed therethrough, in combination with housing 112 may serve to regulate flow of oxygen into heat engine 110 and/or to direct any generated steam and/or water vapor towards the bottom surface of the cleaning pad 100 (i.e., towards bottom layer 104b). Housing 112 may also be impermeable to such steam and/or water vapor, ensuring the emission of the steam and/or water vapor is only through pad layer 104b. Another thin membrane layer of impermeable material (e.g., polypropylene, polyethylene, or the like) similar to layer 106 may be provided above heat engine 110 (e.g., between heat engine 110 and housing 112, or on top of housing 112, as desired.

As described herein, the heat engine (e.g., 110) is advantageously incorporated into the substrate of the pad, wipe, or other cleaning article. For example, the heat engine 110 is embedded within the substrate itself, rather than simply positioned adjacent to the substrate. Such placement of the heat engine is advantageous as it allows generation of the heat within the substrate of the pad or wipe itself, and allows generation of steam or water vapor that may be emitted from the interior of the substrate.

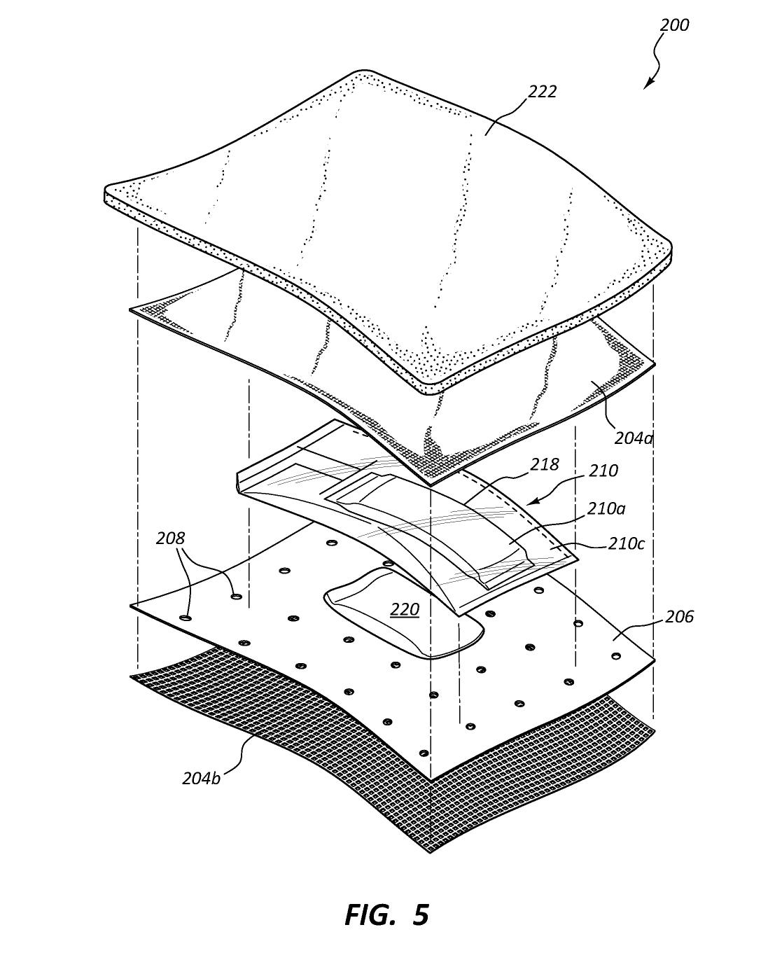

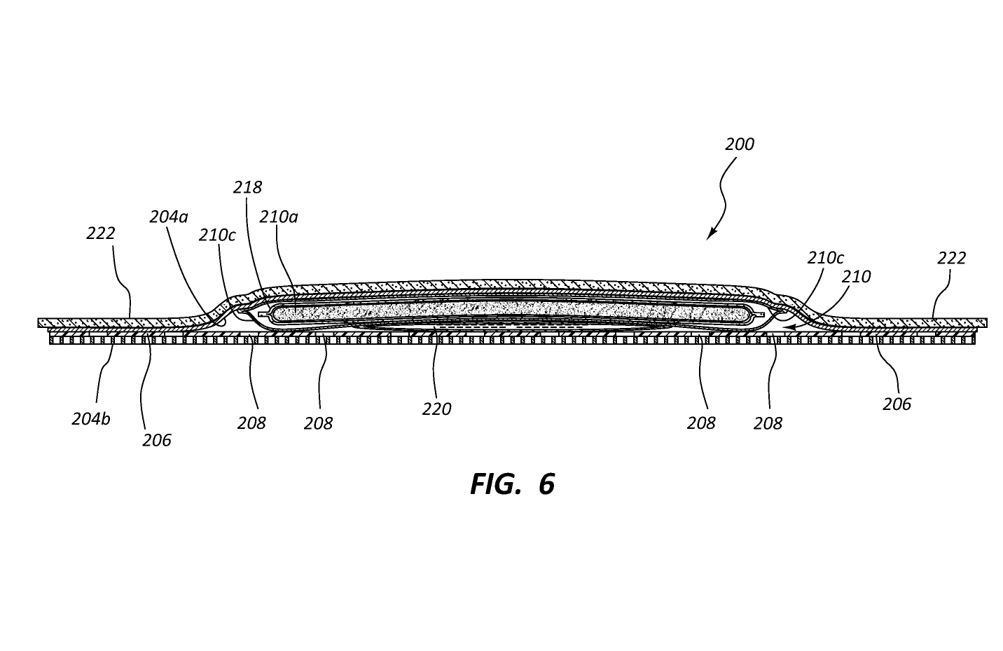

FIGS. 4-6 illustrate another example of a cleaning article configured as a pad 200, without any handle, e.g., configured for hand-held use. Cleaning article or pad 200 may be similarly configured to cleaning pad 100 in many respects. For example, FIG. 5 shows an exploded view, showing various layers and components that may be present. As shown in FIG. 5, a substrate 204 may be provided, including one or more layers. For example, a porous, absorbent, non-woven fibrous web bottom layer 204b may be provided. For example, the heat engine 210, and impermeable vent layer 206 including vent holes 208 may be surrounded by substrate layers 204b (at bottom) and layer 204a (at top). During manufacture, the various layers may be heat sealed or otherwise attached together (e.g., bonded with an adhesive). Combinations of such attachment mechanisms may of course be employed. Such heat sealing or other attachment may of course apply to the other embodiments described herein, as well.

In the illustrated embodiment, the heat engine 210 is shown as including a pouch 218 of the reactive metal composition 210a. Pouch 218 may itself be provided within another pouch 210c. By way of example, one of pouches 218 or 210c may be a non-woven, porous, or otherwise permeable, while the other of pouches 218 or 210c (e.g., inner pouch 218) is impermeable to air, but upon twisting, bending, or otherwise rupturing pouch 218, oxygen is allowed to enter therein. An optional cleaning composition pouch 220 is also illustrated in FIG. 5, which may function similar to cleaning composition 120 described above.

FIG. 4A shows pad 200 enclosed within a resealable pouch 218′. Pouch 218′ may be impermeable to air, so that when the user is done using pad 200, but some zinc or other reactive metal still remains for generating heat, the pad 200 could simply be placed within pouch 218′, cutting off supply of reactive oxygen, until it is desired to use pad 200 again (e.g., at which time the pad 200 is simply removed from pouch 218′.

Where cleaning pad 200 is intended for hand-held use, one important consideration is the prevention of burning to the hands of the user, as the user grips or otherwise holds the pad 200 in their hand. Where the temperatures generated by the heat engine 210 are sufficiently high, it may thus be desirable to provide an insulative heat barrier layer 222. For example, such layer 222 may provide sufficiently low thermal conductivity so as to be sufficiently cool, even when the heat engine 210 is activated, so that a user may grip the “top” face of the cleaning article (adjacent layer 222), without risk of being burned. Such a layer 222 may thus insulate the hand of the user from the heat of the heat engine 210. As shown, such a layer 222 may be positioned opposite the bottom layer 204b, between the bottom layer 204b and the heat engine 210.

The heat barrier layer may comprise a variety of materials selected for their relatively low thermal conductivity, and/or ability to provide a barrier that provides low permeability or impermeability to water, water vapor, and/or steam. Suitable examples include but are not limited to: polyethylene films, polypropylene films, aluminum foils, foams, high loft non-woven materials (e.g. batting), cork, rubber, etc.

Any of the selectively heatable cleaning articles may include a phase change material on or within the article that may aid in regulating the temperature achieved by the cleaning article. For example, a material may be present that absorbs heat associated with a liquid to gas, solid to liquid, or other change in phase. Such heat energy could be released upon reversal of the phase change. Such a material may temper or otherwise regulate the temperatures achieved during activation of the heat engine. Examples of such materials include paraffin or other wax, fatty acids, hydratable or deliquescent salts, salt hydrates, polymers, and combinations thereof.

The phase-change material may include any material exhibiting a softening, melting or boiling point or phase transition at or around the target temperature or at an intermediate desired temperature of the article. The optional phase change material operates by absorbing some amount of the heat generated by the heat engine, absorbing it in some manner and then releasing the heat in a controlled and predictable manner. Without being bound by theory, the phase-change material absorbs heat to become heated to a higher than initial temperature and undergoes a phase change to a higher energy state configuration (e.g. dehydration and/or hydration of a material to a higher energy state configuration, or some other similar chemical and/or physical change etc., including simple thermal heat absorption and retention) and then releases the heat in a controlled manner to the surrounding structures and/or treatment surfaces.

In one embodiment, the phase change material operates to “smooth” out and/or control the overall emitted heat content and/or temperature profile of the heat engine, the heated article or both, and optionally the surface temperature of the surface being cleaned or treated with the activated heated article during use and contact with that surface. Alternatively, the phase change material may operate to “regulate” the temperature output of the treatment device to either prevent the generation of an excessively high and undesired temperature. The phase-change material may extend the heating effect of the treated article by first absorbing and then later releasing heat at a time period after the primary heat generation and release of energy from the air battery component has decreased and/or terminated.

In one embodiment, the presence of a sufficient quantity of phase-change material operates to prevent overheating of the treatment article by first absorbing a rapid initial increase in temperature and heat released from the heat engine, and then subsequently re-releasing this absorbed heat in a slower and thus more controlled manner. In addition, the optional phase change material operates to maintain a more uniform and steady temperature and/or regulate the heat production of the treatment article by redistributing the generated heat more uniformly across the physicality of the treatment device. Essentially, the phase-change material can enable the heat to dissipate and more uniformly heat the entire heated article and eliminate any undesired hot and/or cold spots. Furthermore, the phase change material can operate to extend the heat release from the treatment article even after the heat engine itself has ceased producing heat. For example, after all the reactive material in the heat engine has reacted or the heat engine is deactivated or stopped by the user, the phase-change material may then operate to allow heat to continue to be released from the treatment article as the phase-change material reverts to its initial state and releases any absorbed and/or stored thermal energy.

It will be apparent that the pad 200 of FIGS. 4-6 may thus not include any rigid components (e.g., no rigid scaffold or housing 112, as in FIG. 1). Of course, in another embodiment, a rigid scaffold, housing, or other rigid layer could be provided, e.g., adjacent the top gripping side of the article, if desired.

In order to activate the heat engine 210, the user need only rupture or otherwise open whatever pouch (e.g., pouch 218) is separating reactive metal 210a from oxygen. Upon such rupture, the oxygen contacts the reactive metal 210a, leading to generation of the desired heat.

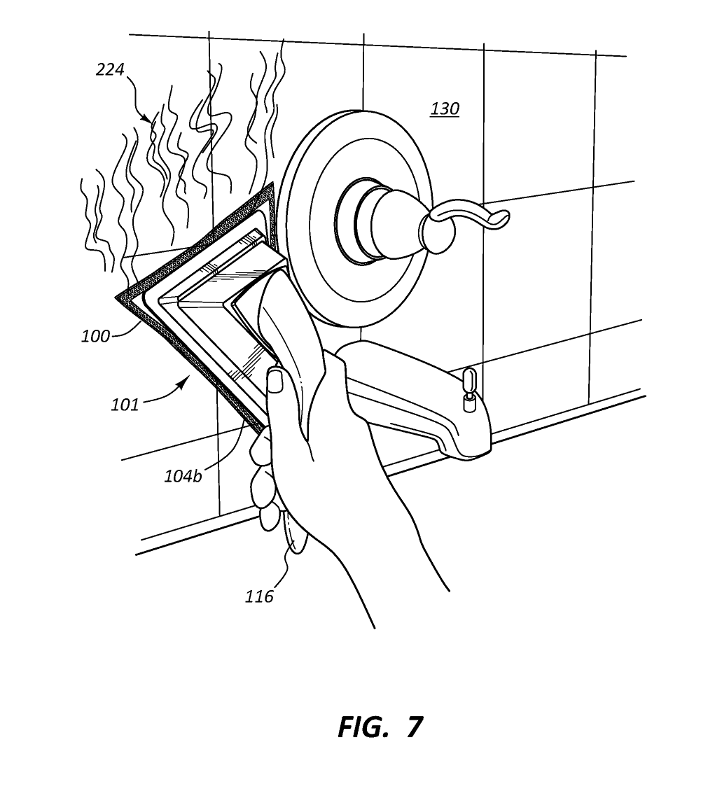

The cleaning articles may advantageously be employed in cleaning a wide variety of surfaces. By way of example, FIG. 7 shows the cleaning article 101 of FIGS. 1-3 being used to scrub tile 130 within a shower or bathtub. FIG. 7 shows steam and/or water vapor 224 being emitted from the heated cleaning pad 100 exiting through the bottom face associated with substrate layer 104b. It will be appreciated that in some embodiments, heat, without other cleaning composition, is simply emitted. Such heat may increase the efficacy of a cleaning composition applied by the user (or present within pad 100). Such emission aids in removal of the soils, debris, and other undesirable materials being scrubbed from the surface. The heat associated pad 100 may further be beneficial in killing mold, mildew, or other undesirable organisms that may be present. Of course, other cleaning actives, e.g., bleach, surfactants, antimicrobials, and the like may also be delivered (e.g., through cleaning composition 120). Many such active components will exhibit increased efficacy when delivered under such heated conditions.

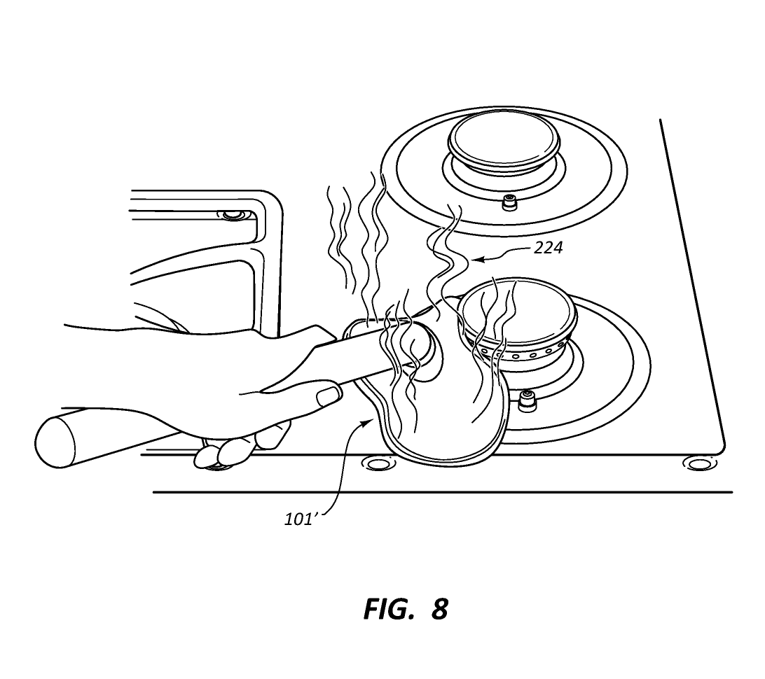

FIG. 8 shows another cleaning article 101′ similar to that of FIG. 7, but with a differently configured handle, and showing how the cleaning article itself may be of any desired shape or configuration. Water vapor, steam, and/or heated composition 224 aids in cleaning and removal of spills, soils, debris, and other materials to be removed at the desired cleaning site (e.g., a stovetop, as shown, or other kitchen, bathroom, countertop, or other surface). Although FIGS. 1 and 8 show a relatively short handle, it will be appreciated that other handles, tools, etc. may be attached to the cleaning pad. For example, a mop handle could be attached.

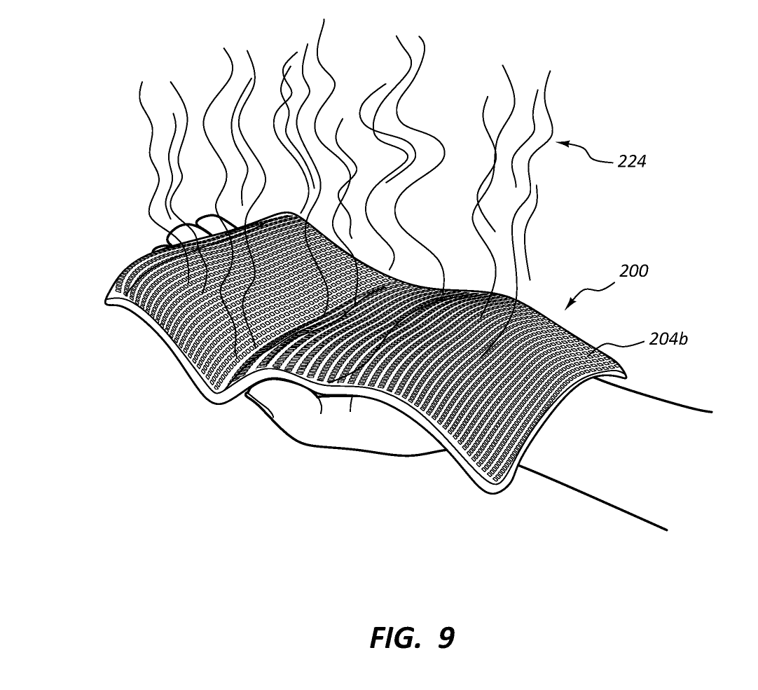

FIG. 9 shows how the cleaning device 200 of FIGS. 4-6 may be held within the user's hand, with the insulative heat barrier layer 222 oriented adjacent the user's hand, so that even when activated, and held within the user's hand, the hand is not burned. This may be so, even when the surface temperature adjacent bottom cleaning surface 204b may be within any of the ranges described herein (e.g., about 160° F.). This is because of the presence of the heat barrier layer 222 adjacent the user's hand, which insulates the user's hand from the heat generated by the heat engine 210. In addition, optional venting structures provided by layer 206, vents 208, may direct any generated steam and/or water vapor, or other heated materials away from the user's hand, towards the bottom surface and layer 204b, where it can be emitted adjacent the surface to be cleaned or otherwise treated. As shown in FIG. 9, use of the term “bottom” with respect to layer 204b is relative, as when the pad 200 is flipped over as shown, bottom layer 204b may be oriented towards the top.

Similarly, one or more layers or portions (e.g. pouches) of the substrate may comprise membranes which may be impervious to air, water, moisture (water vapor), or which may have relatively low permeability to one or more of air, oxygen, water, water vapor, steam, and the like. Suitable examples include but are not limited to films and membranes comprising: polyethylene, polypropylene, polyalkylenes, copolymers thereof, and other suitable materials. Suitable films and membranes may have a variety of structures, including but not limited to: coatings, films, laminates, layers of materials, pouches, bubbles, channels, strips, etc.

In an embodiment, the substrate may include one or more layers that act as an absorbent material, to aid in holding liquid water or cleaning composition that may be present. For example, such an absorbent material may be used in connection with the venting structure to absorb, capture, regulate (e.g., slowly release) water to keep it from dripping or escaping from the heated cleaning article in an undesirable or unsafe manner. For example, a super absorbent polymer (SAP) could be combined or commingled with the reactive metal mixture, or positioned within a substrate layer in order to capture liquids. Along the same lines, an alternative fluid absorbing medium such as wood pulp or other materials capable of adsorbing liquid can be employed. In yet another related embodiment, a reversible SAP that releases its contents when compressed, such as for example, but not limited to a low density cross-linked SAP could also be employed.

In addition to cleaning of various hard surfaces as shown in FIGS. 7-8, it will be appreciated that such a wipe or pad could be used to treat other surfaces, e.g., skin. For example, a heated skin care lotion or other treatment composition could similarly be applied, e.g., scrubbed into the skin using an article such as the pad seen in FIG. 9.

A. Substrate Materials

The cleaning articles according to the present invention include some sort of cleaning substrate material, e.g., a wipe or other substrate. Such a substrate of the present invention may include one or more layers of material. In an embodiment, one or more of the layers may be a nonwoven. Exemplary nonwoven materials may be meltblown, spunbond, spunlaid, SMS (spunbond-meltblown-spunbond), coform, airlaid, wetlaid, carded webs, thermal bonded, through-air-bonded, thermoformed, spunlace, hydroentangled, needled, chemically bonded, or combinations thereof.

“Meltblown” means fibrous webs formed by extruding a molten thermoplastic material through a plurality of fine, usually circular, die capillaries as molten threads or filaments into converging high velocity heated gas. (e.g., air) streams, which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al, which is hereby incorporated by reference in its entirety. Meltblown fibers are microfibers which may be continuous or discontinuous, are generally smaller than about 0.6 denier, and are generally self-bonding when deposited onto a collecting surface. Meltblown fibers used in the present invention may be substantially continuous in length.

“Spunbond” refers to fibrous webs comprised of small diameter fibers which are formed by extruding molten thermoplastic material as filaments from a plurality of fine capillaries of a spinneret having a circular or other configuration, with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartmann, U.S. Pat. No. 3,502,538 to Petersen, and U.S. Pat. No. 3,542,615 to Dobo et al., each of which is incorporated herein in its entirety by reference. Spunbond fibers are quenched and generally not tacky when they are deposited onto a collecting surface. Spunbond fibers are generally continuous and often have average denier values larger than about 0.3, more typically, between about 0.6 and 10.

A multilayer laminate may include layers formed by multiple processes. For example, one or more layers may be spunbond and one or more layers may be meltblown such as a spunbond/meltblown/spunbond (SMS) laminate as disclosed in U.S. Pat. No. 4,041,203 to Brock et al. and U.S. Pat. No. 5,169,706 to Collier, et al., each hereby incorporated by reference in its entirety. The SMS laminate may be made by sequentially depositing onto a moving conveyor belt or forming wire first a spunbond web layer, then a meltblown web layer and last another spunbond layer and then bonding the laminate in a manner described above. Alternatively, the three web layers may be made individually, collected in rolls and combined in a separate bonding step.

“Spunlaid” materials are nonwoven fabrics made by the extrusion of filaments which are then laid down in the form of a web and subsequently bonded. The subsequent bonding of the filaments may be accomplished by a variety of different bonding techniques.

As used herein, the term “through-air bonding” or “TAB” refers to a process of bonding a nonwoven, for example, a bicomponent fiber web in which air which is sufficiently hot to melt one of the polymers of which the fibers of the web are made is forced through the web. The air velocity may be from about 100 to about 500 feet per minute and the dwell time may be as long as about 6 seconds. The melting and re-solidification of the polymer provides the bonding. Through-air bonding has relatively restricted variability since it requires the melting of at least one component to accomplish bonding. It is therefore particularly useful in connection with webs with two components like conjugate fibers or those which include an adhesive. In the through-air bonder, air having a temperature above the melting temperature of one component and below the melting temperature of another component is directed from a surrounding hood, through the web, and into a perforated roller supporting the web. Alternatively, the through-air bonder may be a flat arrangement wherein the air is directed vertically downward onto the web. The operating conditions of the two configurations may be similar, the primary difference being the geometry of the web during bonding. The hot air melts the lower melting polymer component and thereby forms bonds between the filaments to integrate the web.

“Hydroentangled” and “spunlace” refer to materials created by a method that involves forming either a dry-laid or wet-laid fiber web, where the fibers are entangled by means of very fine water jets under high pressure. Multiple rows of water jets may be directed towards the fiber web, which is carried on a moving wire. The entangled web is thereafter dried. Those fibers which are used in the material can be natural, synthetic or regenerated staple fibers, e.g., polyester, polyamide, polypropylene, rayon and the like, pulp fibers or a mixture of pulp fibers, and staple fibers. Spunlace material can be produced to a high quality at reasonable cost and display high absorption capability relative to many other methods. Spunlace materials are frequently used as wiping materials for household or industrial applications and as disposable materials within health care industries, etc.

As used herein, the term “coform” means a process in which at least one meltblown diehead is arranged near a chute through which other materials are added to the base material or the web while it is forming. Such other materials may be pulp, superabsorbent particles, cellulose or staple fibers, for example. Coform processes are shown in U.S. Pat. No. 4,818,464 to Lau, herein incorporated by reference in its entirety.

The term “carded web” refers to non-woven materials formed by the disentanglement, cleaning and intermixing of fibers to produce a continuous web, of generally uniform basis weight, suitable for subsequent processing. This is achieved by passing the fibers between relatively moving surfaces covered with card clothing. The carding processes will be readily apparent to those skilled in the art and are further described, for example, in U.S. Pat. No. 4,488,928 to Alikhan and Schmidt, each of which is incorporated by reference in its entirety.

As used herein, “bonded carded web” refers to webs that are made from staple fibers which are sent through a combing or carding unit, which breaks apart and aligns the staple fibers in the machine direction to form a generally machine direction-oriented fibrous non-woven web. Such fibers are usually purchased in bales which are placed in a picker which separates the fibers prior to the carding unit. Once the web is formed, it then is bonded by one or more of several known bonding methods. One such bonding method is powder bonding, wherein a powdered adhesive is distributed through the web and then activated, usually by heating the web and adhesive with hot air. Another suitable bonding method is pattern bonding, wherein heated calendar rolls or ultrasonic bonding equipment are used to bond the fibers together, usually in a localized bond pattern, though the web can be bonded across its entire surface if so desired. Another suitable and well-known bonding method, particularly when using conjugate staple fibers, is through-air bonding. Other suitable and well-known methods are hydroentangling or needling. Carded webs that are hydroentangled are often referred to as spunlaced.

The non-wovens used in the cleaning articles according to the invention may be produced by any of the processes described above or any combinations of these processes. In addition, various other processes for making a non-woven substrate may also be used.

One or more layers of the substrate may comprise natural fibers, synthetic fibers, or combinations thereof. Exemplary fibers include, but are not limited to polypropylene, polyethylene, polyester, PET, wood pulp, regenerated cellulose, nylon, cotton, bicomponent fibers, continuous fibers, and combinations thereof including blends or layers of one or more of the above fibers. Suitable thermoplastic fibers can be made from a single polymer and/or copolymer (monocomponent fibers), or can be made from fibers composed of more than one polymer or copolymer (e.g., bicomponent or multicomponent fibers). Multicomponent fibers are described in U.S. Pat. App. 2003/0106568 to Keck and Arnold, herein incorporated by reference in its entirety. Bicomponent fibers are described in U.S. Pat. No. 6,613,704 to Arnold and Myers, herein incorporated by reference in its entirety. Multicomponent fibers of a wide range of denier or dtex are described in U.S. Pat. App. 2002/0106478 to Hayase et. al., herein incorporated by reference in its entirety.

B. Additional Disclosure Relative to Venting Structures

According to an embodiment, the heated cleaning articles may enable the article to generate enough heat to release water vapor and/or steam where water to be heated is present, yet prevent or minimize release of other components of the heat engine. Such vents 108, 208 are shown in FIGS. 2-3 and 5-6, as described above where the cleaning article may include an impermeable layer, with one or vents (e.g., holes) through at least one surface of the impermeable layer. As shown in FIG. 2, the vents may be disposed on one face (e.g., the underside, or cleaning face) of the cleaning article, away from the user, or away from where the handle attaches to the cleaning article. Such placement may advantageously direct heated water vapor and/or steam exiting the vents to the cleaning face of the cleaning article. Such may also prevent or minimize inadvertent contact of such heated water vapor or steam from contacting the user, for increased safety.

In one embodiment of the present invention the heated article comprises a pouch within a pouch. In this embodiment, an inner pouch contains the entire heat engine assembly. The outer pouch may be formed of a material that is impermeable to liquid and gas, and may have vent holes located on one face only (the cleaning face of the article), allowing air to enter therethrough, and also restricting the water vapor and/or steam so that it escapes only from the face of the wipe that is to be applied against the surface to be treated. In the event that the heated article is a different three-dimensional shape than a wipe, it may be desirable to have at least some of the vents located on one or more lateral sides of the heated article. This may be particularly advantageous if the heated article is intended to be used with a cleaning tool that would allow the user to be at a safe distance from the heated article so that they would not be exposed to or contact the heated water vapor and/or steam flowing out of the heated cleaning article. In one embodiment, it may be desirable to have some of the vents located on the top of the heated article such that the steam is more visible to the consumer.

In an embodiment, the cleaning article features a heat engine assembly positioned within a pouch that has one or more openings, but which employs a channel in the form of a tortuous path (e.g., a non-linear channel, maze-like path) that may end with a “chimney” or opening which enables the article to retain and store the bulk heated water (saline solution), yet allow heated water vapor and/or steam to exit after following the torturous path to the chimney, which may be open to the outside surface of the article.

In another embodiment, steam vent channels are shortened and/or made less tortuous in design so that after activating of a treatment article according to the present invention, the heated water and hot water vapor in addition to steam is released from the treatment article through the vent channels, thus being able to dissolve or interact with a cleaning/treatment composition that has previously been applied to the exterior of the treatment article in or near the vicinity of one or more vent channels.

One of the side effects of steam and/or water vapor generated by the heated cleaning article may be a “pillowing” or “ballooning” of the cleaning article during use, due to pressurization within the wipe or other substrate during activation of the heat engine. It may be desirable to prevent too much pillowing from occurring. For example, internal bridges could be formed by heat sealing during a compression stage of manufacturing, or the use of compartments, and/or attachment zones between the two extreme outer layers of the cleaning article could be provided to prevent excessive pillowing during use. In another embodiment, the cleaning article may include a pressure release valve on or adjacent to the surface that is being brought to bear (the cleaning surface) against the surface of an object being scrubbed or otherwise cleaned. This may allow the consumer to press the article during use, increasing release of steam and/or water vapor, giving the user control to direct more of the heated water vapor and/or steam against the target surface being treated.

Alternatively, the pillowing characteristic could be used to inflate a protruding handle on the cleaning article, which could be gripped to help maintain control during cleaning.

C. Air Flow Structures

Because embodiments of the heated cleaning articles rely on reaction of a reactive metal with oxygen, various air flow structures may be provided within the wipe, pad, or other cleaning article. For example, one or more air flow structures (e.g. baffles, channels, ridges, and the like) may be provided within the article. In an embodiment, the reactive metal composition of the heat engine may be formed into a solid material and air flow channels may be formed in the shape of the reactive metal composition itself. In another embodiment, the heat engine may be formed in a pattern onto a base supportive structure so that it forms a pattern of channels or islands that allow air to flow in and around the surfaces of the heat engine's reactive metal composition. In alternative embodiment, air flow channels may be formed in a layer of material that is adjacent or proximate to the heat engine, (e.g. a heat barrier layer, a phase-change material layer, or the like).

The process for forming such air flow channels may be by any suitable manufacturing process, e.g., by printing the heat engine material as a pattern onto a base supportive layer. Similarly, air flow channels may be formed into phase-change or other materials by printing as well. Alternatively, the air flow channels may be etched into the heat engine or phase-change material layer. In another embodiment, air flow channels may be present in the heat barrier layer. For example, layer 222 (and layer 204a) shown in FIGS. 4-6 may be porous, so as to include air flow channels therethrough, allowing air to access heat engine 210. In another embodiment, discrete channels may be machined or otherwise formed into layer 222 or any other layer, to provide channels for passage of such activating air. Vent holes 208 are another example of such structure that may provide channels for passage of activating air. It should be appreciated that there are a wide variety of ways to create the air flow structure in or around the heat engine.

Another embodiment may include treatment to one or more regions on the wipe substrate that have been modified with a hydrophobicizing material (for example, but not limited to treatment with either one or combination of a silylation, silanolation, perfluorylation or hydrophobizing reagent) that renders that area water-resistant and/or water-repellant. Such may operate to prevent wetting or wicking of water, and/or moisture intrusion into the modified region(s). Such an embodiment may be desirable where it is desired that such region(s) remain relatively dry and free of water or cleaning composition applied to or emitted from the pad. For example, wetted fabrics tend to exhibit a significantly decreased rate of air flow across their dimensionality.

Such modified regions could be used to augment air flow through layer(s) of an otherwise wetted substrate, to increase air flow into the heat engine. Such modified region(s) could be a single region (e.g., in the center), or be a plurality of such regions, spaced apart over the surface of the substrate.

D. Cleaning Compositions

As described herein, the wipe, pad, or other cleaning article may include a cleaning composition therein. By way of example, such a cleaning composition may typically be aqueous, although it will be appreciated that a thickened lotion, substantially dry to the touch cleaning composition, or other cleaning composition may be provided on or within the wipe or pad. Examples of components that may be included in such a cleaning composition include, but are not limited to one or more of an oxidant (e.g., bleaching agent), electrolyte, surfactant, solvent, antimicrobial agent, buffer, stain and soil repellant, lubricant, odor control agent, perfume, fragrance, fragrance release agent, acid, base, dyes and/or colorant, solubilizing material, stabilizer, thickener, defoamer, hydrotrope, cloud point modifier, preservatives, polymer, and combinations thereof.

1. Oxidants

The cleaning compositions may include one or more oxidants and/or bleaching agents. Preferred oxidants include, but are not limited to, hydrogen peroxide, alkaline metal salts and/or alkaline earth metal salts of hypochlorous acid (e.g., sodium hypochlorite), hypochlorous acid, solubilized chlorine, any source of free chlorine, solubilized chlorine dioxide, acidic sodium chlorite, active chlorine generating compounds, active oxygen generating compounds, chlorine-dioxide generating compounds, solubilized ozone, sodium potassium peroxysulfate, sodium perborate, and combinations thereof. When present, the one or more oxidants can be present at a level of from 0.001% to 10%, from 0.01% to 10%, from 0.1% to 5%, or from 0.5% to 2.5% by weight.

2. Buffers & Electrolytes

Buffers, buffering agents and pH adjusting agents, when used, include, but are not limited to, organic acids, mineral acids, alkali metal and alkaline earth salts of silicate, metasilicate, polysilicate, borate, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2methylpropanol. Exemplary buffering agents include dicarboxlic acids, such as, succinic acid and glutaric acid. Some suitable nitrogen-containing buffering agents are amino acids such as lysine or lower alcohol amines like mono-, di-, and tri-ethanolamine. Other nitrogen-containing buffering agents are Tri(hydroxymethyl) amino methane (HOCH₂)₃CNH₃ (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine (bicine) and N-tris(hydroxymethyl)methyl glycine (tricine). Other exemplary buffers include ammonium carbamate, citric acid, and acetic acid. Mixtures of one or more buffers may also be acceptable. Useful inorganic buffers/alkalinity sources include ammonia, the alkali metal carbonates and alkali metal phosphates, e.g., sodium carbonate, sodium polyphosphate. By way of example, when present, the buffer may be preferably present at a concentration of from about 0.001% to about 20%, from about 0.05% to about 1%, from about 0.05% to about 0.5%, or from about 0.1% to about 0.5% by weight.

3. Antimicrobial Agents

The cleaning compositions may include antimicrobial (germicidal) agents or biocidal agents. Such antimicrobial agents can include, but are not limited to, alcohols, chlorinated hydrocarbons, organometallics, halogen-releasing compounds, metallic salts, pine oil, organic sulfur compounds, iodine compounds, silver nitrate, quaternary ammonium compounds (quats), chlorhexidine salts, and/or phenolics. Antimicrobial agents suitable for use in the compositions of the present invention are described in U.S. Pat. Nos. 5,686,089; 5,681,802, 5,607,980, 4,714,563; 4,163,800; 3,835,057; and 3,152,181, each of which is herein incorporated by reference in its entirety.

Also useful as antimicrobial agents are the so-called “natural” antibacterial actives, referred to as natural essential oils. These actives derive their names from their natural occurrence in plants. Suitable antimicrobial agents include alkyl alpha-hydroxyacids, aralkyl and aryl alpha-hydroxyacids, polyhydroxy alpha-hydroxyacids, polycarboxylic alpha-hydroxyacids, alpha-hydroxyacid related compounds, alpha-ketoacids and related compounds, and other related compounds including their lactone forms. Preferred antimicrobial agents include, but are not limited to, alcohols, chlorinated hydrocarbons, organometallics, halogen-releasing compounds, metallic salts, pine oil, organic sulfur compounds, iodine, compounds, antimicrobial metal cations and/or antimicrobial metal cation-releasing compounds, chitosan, quaternary alkyl ammonium biocides, phenolics, germicidal oxidants, germicidal essential oils, germicidal botanical extracts, alpha-hydroxycarboxylic acids, and combinations thereof. When included, the one or more antimicrobial agents may be present at a concentration of from about 0.001% to about 10%, from about 0.05% to about 1%, from about 0.05% to about 0.5%, or from 0.1% to about 0.5% by weight.

4. Solvents

Water may be used as a solvent alone, or in combination with any suitable organic solvents. Such solvents may include, but are not limited to, C₁₋₆ alkanols, C₁₋₆ diols, C₁₋₁₀ alkyl ethers of alkylene glycols, C₃₋₂₄ alkylene glycol ethers, polyalkylene glycols, short chain carboxylic acids, short chain esters, isoparafinic hydrocarbons, mineral spirits, alkylaromatics, terpenes, terpene derivatives, terpenoids, terpenoid derivatives, formaldehyde, and pyrrolidones. Alkanols include, but are not limited to, methanol, ethanol, n-propanol, isopropanol, butanol, pentanol, and hexanol, and isomers thereof. In one embodiment of the invention, water may comprise at least 30%, at least 40%, at least 50%, at least 60%, at least 70%, at least 80%, at least 90%, or at least 95% of a cleaning composition by weight. Of course, lotions, or dry to the touch cleaning compositions will typically have relatively lower water concentration. Where included, one or more organic solvents can be present at a level of from 0.001% to 10%, from 0.01% to 10%, from 0.1% to 5%, or from 1% to 2.5% by weight.

5. Surfactants

A cleaning composition included within the wipe or pad of the present invention may contain surfactants selected from nonionic, anionic, cationic, ampholytic, amphoteric and zwitterionic surfactants and mixtures thereof. A typical listing of anionic, ampholytic, and zwitterionic classes, and species of these surfactants, is given in U.S. Pat. No. 3,929,678 to Laughlin and Heuring. A list of suitable cationic surfactants is given in U.S. Pat. No. 4,259,217 to Murphy. Where present, the one or more surfactants may be present at a level of from 0% to about 90%, from about 0.001% to about 50%, or from about 0.01% to about 25% by weight. Alternatively, surfactants may be present at a level of from about 0.1% to about 10%, from about 0.1% to about 5%, or from about 0.1% to 1% by weight. Where sudsing action is desired from the cleaning composition, a surfactant that generates foam may be desired.

6. Additional Adjuvants

The cleaning compositions may optionally contain one or more of the following adjuncts: stain and soil repellants, lubricants, odor control agents, perfumes, fragrances and fragrance release agents, and bleaching agents. Other adjuncts include, but are not limited to, acids, bases, dyes and/or colorants, solubilizing materials, stabilizers, thickeners, defoamers, hydrotropes, cloud point modifiers, preservatives, chelating agents, water-immiscible solvents, enzymes and polymers.

Without departing from the spirit and scope of the invention, one of ordinary skill can make various changes and modifications to the invention to adapt it to various usages and conditions. As such, these changes and modifications are properly, equitably, and intended to be, within the full range of equivalence of the following claims.

1. A selectively heatable cleaning article comprising:
(a) a substrate material comprising one or more layers;
(b) a heat engine comprising a reactive metal composition that generates heat upon contact with oxygen; and
(c) a handle attachable to the cleaning substrate.

2. The heated article of claim 1, wherein the reactive metal composition comprises metals selected from the group consisting of: zinc, aluminum, iron, magnesium, and mixtures thereof.

3. The heated article of claim 1, wherein the reactive metal composition comprises zinc.

4. The heated article of claim 1, wherein the reactive metal composition further comprises a carbon promotor.

5. The selectively heatable cleaning article of claim 1, wherein the selectively heatable cleaning article further comprises a heat barrier layer on a face opposite from the surface of the cleaning article that bears against a surface to be cleaned during use.

6. The selectively heatable cleaning article of claim 1, further comprising an oxygen impermeable pouch or membrane surrounding the reactive metal composition.

7. The selectively heatable cleaning article of claim 6, wherein the oxygen impermeable pouch or membrane is frangible.

8. The selectively heatable cleaning article of claim 1, further comprising an oxygen impermeable pouch or membrane that is resealable.

9. The selectively heatable cleaning article of claim 1, further comprising a venting structure surrounding or adjacent to the heat engine comprising an impermeable material containing one or more vents through at least one face of the impermeable material for allowing entry of oxygen into the heat engine and/or for releasing steam and/or water vapor heated by the heat engine.

10. The selectively heatable cleaning article of claim 1, wherein the selectively heatable cleaning article further a rigid housing that allows pressure to be applied to the article by the handle or otherwise, while reducing or preventing seepage of any liquid water or cleaning composition due to compression.

11. The selectively heatable cleaning article of claim 1, wherein the selectively heatable cleaning article further comprises a cleaning composition.

12. The selectively heatable cleaning article of claim 1, wherein the selectively heatable cleaning article further comprises a phase change material on or within the article that regulates temperature achieved by the cleaning article.

13. The selectively heatable cleaning article of claim 1, wherein one or more of the one or more layers of the substrate are absorbent to minimize or prevent dripping of liquid water from the heat engine.

14. A selectively heatable cleaning article comprising:
(a) a cleaning substrate material comprising one or more layers;
(b) a heat engine comprising a reactive metal composition that generates heat upon contact with oxygen; and
(c) an oxygen impermeable pouch or membrane surrounding the reactive metal composition;
(d) a venting structure surrounding the heat engine comprising an impermeable material containing one or more vents on at least one face of the impermeable material for allowing oxygen to enter the reactive metal composition upon rupture or opening of the oxygen impermeable pouch or membrane surrounding the reactive metal composition.

15. The selectively heatable cleaning article of claim 14, wherein the reactive metal composition comprises zinc and a promotor.

16. The selectively heatable cleaning article of claim 14, wherein one or more of the one or more layers of the substrate are absorbent to minimize or prevent dripping of liquid water from the heat engine.

17. The selectively heatable cleaning article of claim 14, further comprising a cleaning composition.

18. The selectively heatable cleaning article of claim 14, wherein the selectively heatable cleaning article further comprises a heat barrier layer on a face opposite from the surface of the cleaning article that bears against a surface to be cleaned during use, to allow a user to hold the cleaning article on the face including the heat barrier layer while reducing risk of a burn.

19. A method of using a selectively heatable cleaning article to clean or treat a surface, the method comprising:
(a) providing a selectively heatable cleaning article comprising:
(i) a substrate material comprising one or more layers;
(ii) a heat engine comprising a reactive metal composition that generates heat upon contact with oxygen; and
(iii) a cleaning or treatment composition;
(b) activating the heatable cleaning article by exposing the reactive metal composition of the heat engine with oxygen;
(c) contacting the substrate material of the cleaning article with a surface to be cleaned or treated once the substrate material and cleaning composition are heated.

20. The method of claim 19, wherein the cleaning or treatment composition comprises a skin-care treatment composition, the method comprising contacting the substrate material of the cleaning article with a skin surface to be treated once the substrate material and skin-care treatment composition are heated.
